(19) United States
(12) Patent Application Publication
(10) Pub. No.: US 2011/0298195 A1
(43) Pub. Date: Dec. 8, 2011

(54) TANK STAND

(75) Inventors: Tracy C. Slemker, Clayton, OH (US); Paul L. Galloway, Clayton, OH (US)

(73) Assignee: PROSTHETIC DESIGN, INC., Clayton, OH (US)

(21) Appl. No.: 13/151,319

(22) Filed: Jun. 2, 2011

Related U.S. Application Data
(60) Provisional application No. 61/351,383, filed on Jun. 4, 2010.

(51) Int. Cl. B62H 1/00

(52) U.S. Cl. 280/293

(57) ABSTRACT

Fuel tank stands are disclosed. Some example embodiments may include a base configured to engage a chassis of a vehicle; at least one arm comprising a first end pivotably mounted to the base; and a tank support mounted to a second end of the at least one arm, the tank support being configured to selectively engage and at least partially support a fuel tank of the vehicle. Some example embodiments may include a bias, such as a torsion spring, configured bias the arms into a generally upright configuration. Some example embodiments may include a latch configured to retain the arms in a collapsed configuration.

### CROSS REFERENCE TO RELATED APPLICATION

This application claims the benefit of U.S. Provisional Application No. 61/351,383, filed Jun. 4, 2010, which is hereby incorporated by reference.

### BACKGROUND

The present disclosure pertains to fuel tank support stands and, more particularly, to support stands for motorcycle fuel tanks.

### SUMMARY

Fuel tank support stands are generally disclosed. Some example embodiments may include methods, apparatus, and/or systems pertaining to fuel tank support stands, such as tank support stands for motorcycles.

Some example embodiments according to at least some aspects of the present disclosure may include a fuel tank stand for a vehicle, where the vehicle includes a chassis and a fuel tank pivotably mounted to the chassis, at a pivoting end of the fuel tank, so as to be pivoted up from a closed position to an open position in which an end of the fuel tank opposite the pivoting end is lifted to provide access beneath the fuel tank. Some fuel tank stands may include a base configured to be mounted to a chassis of the vehicle, beneath the fuel tank and approximate the pivoting end of the fuel tank; at least one arm comprising a first end pivotably mount to the base, so as to be pivotable between a generally horizontal collapsed position to a generally vertical upright position; and a tank support mounted to a second end of the at least one arm opposite the first end, the tank support being configured to selectively engage and at least partially support the fuel tank of the vehicle in its open position when the at least one arm is in the generally vertical upright position.

Some example motorcycles according to at least some aspects of the present disclosure may include a chassis; a fuel tank pivotably mounted to the chassis, at a pivoting end of the fuel tank, so as to be pivoted up from a closed position to an open position in which an end of the fuel tank opposite the pivoting end is lifted to provide access beneath the fuel tank; and a fuel tank stand including a base mounted to the chassis beneath the fuel tank and approximate the pivoting end of the fuel tank, at least one arm comprising a first end pivotably mount to the base, so as to be pivotable between a generally horizontal collapsed position to a generally vertical upright position, and a tank support mounted to a second end of the at least one arm opposite the first end, the tank support being configured to selectively engage and at least partially support the fuel tank of the vehicle in its open position when the at least one arm is in the generally vertical upright position.

Some example embodiments according to at least some aspects of the present disclosure may include methods for supporting a fuel tank of a vehicle in an open position using a fuel tank stand, where the fuel tank is pivotably mounted to the chassis, at a pivoting end of the fuel tank, so as to be pivoted up from a closed position to the open position in which an end of the fuel tank opposite the pivoting end is lifted to provide access beneath the fuel tank. Some methods may include pivoting the fuel tank from the closed position to approximate the open position; placing a fuel tank stand into an upright configuration by pivoting at least one arm from a generally horizontal collapsed position to a generally vertical upright position, the arm comprising a first end pivotably mount to a base, the base being mounted to a chassis of the vehicle generally beneath the fuel tank and approximate the pivoting end of the fuel tank; and lowering the fuel tank onto a tank support of the fuel tank stand, the tank support being mounted to a second end of the at least one arm opposite the first end and being configured to selectively engage and at least partially support the fuel tank in the open position when the at least one arm is in the generally vertical upright position.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

In the drawings:

FIG. 1 is a perspective view of an example fuel tank stand in an upright configuration;

FIG. 2 is a plan view of an example fuel tank stand base;

FIG. 3 is a rear elevation view of an example fuel tank stand base;

FIG. 4 is a left elevation view of an example fuel tank stand base;

FIG. 5 is a right elevation view of an example tank support;

FIG. 6 is a rear elevation view of an example arm;

FIG. 7 is a rear elevation view of an example hinge barrel; and

FIG. 8 is a right elevation view of an example hinge barrel;

FIG. 9 is a perspective view of an example fuel tank stand in a collapsed configuration;

FIG. 10 is a right elevation view of an example fuel tank stand installed on a motorcycle chassis; and

FIG. 11 is a perspective view of an example fuel tank stand including a spring and a latch; all arranged in accordance with at least some embodiments of the present disclosure.

### DETAILED DESCRIPTION

The present disclosure includes, inter alia, tank support stands and, more particularly, gas tank support stands for motorcycle gas tanks. Some example embodiments may be used with Suzuki Hayabusa motorcycles, for example.

The present disclosure contemplates that some maintenance and/or repair procedures for some motorcycles may include tilting a motorcycle's fuel tank to access components located generally beneath the fuel tank. For example, on Suzuki Hayabusa motorcycles, the fuel tank may be tilted generally rearward (e.g., the forward portion of the fuel tank may be raised) to access components beneath the fuel tank. The fuel tank may be held in such a tilted or open position using a prop rod or similar device to support the fuel tank.

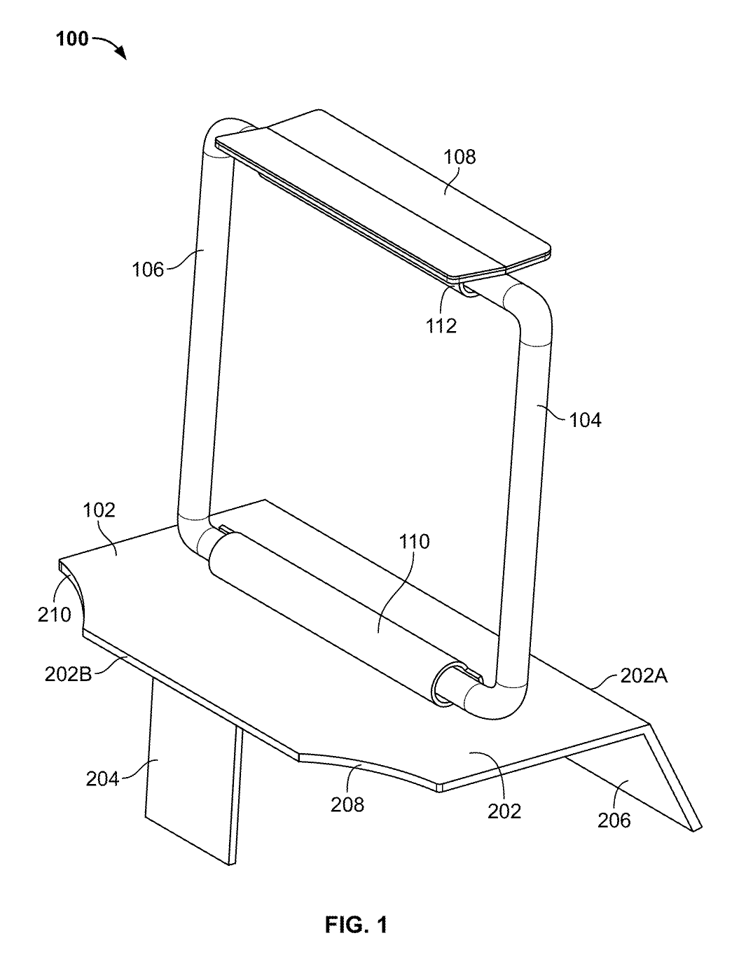

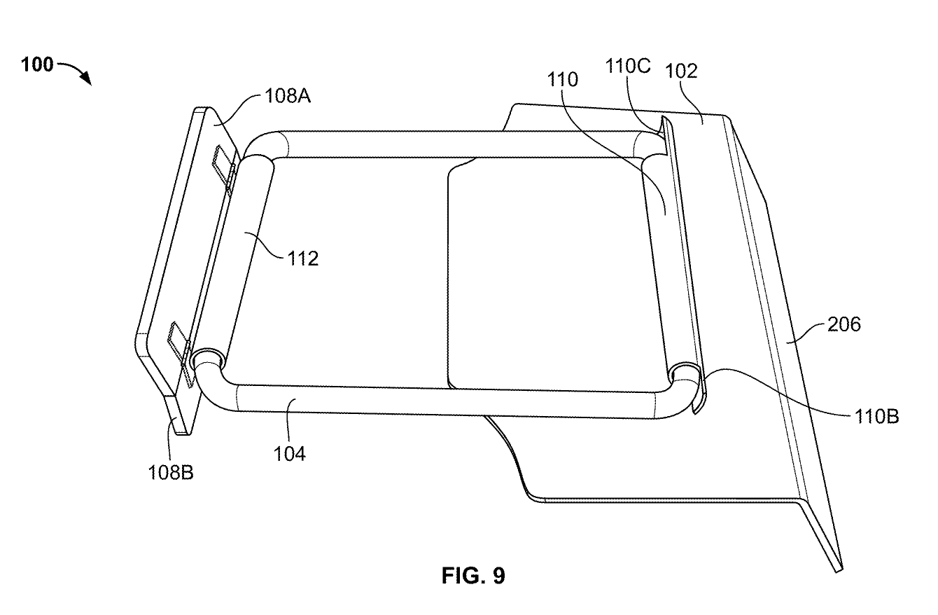

FIG. 1 illustrates an example fuel tank stand 100, which may include a base 102, one or more arms 104, 106, and/or a tank support 108. Arms 104, 106 may be pivotably connected to base 102 by hinge barrel 110. Arms 104, 106 may be connected to tank support 108 by tank support beam 112 (see, also, FIG. 9).

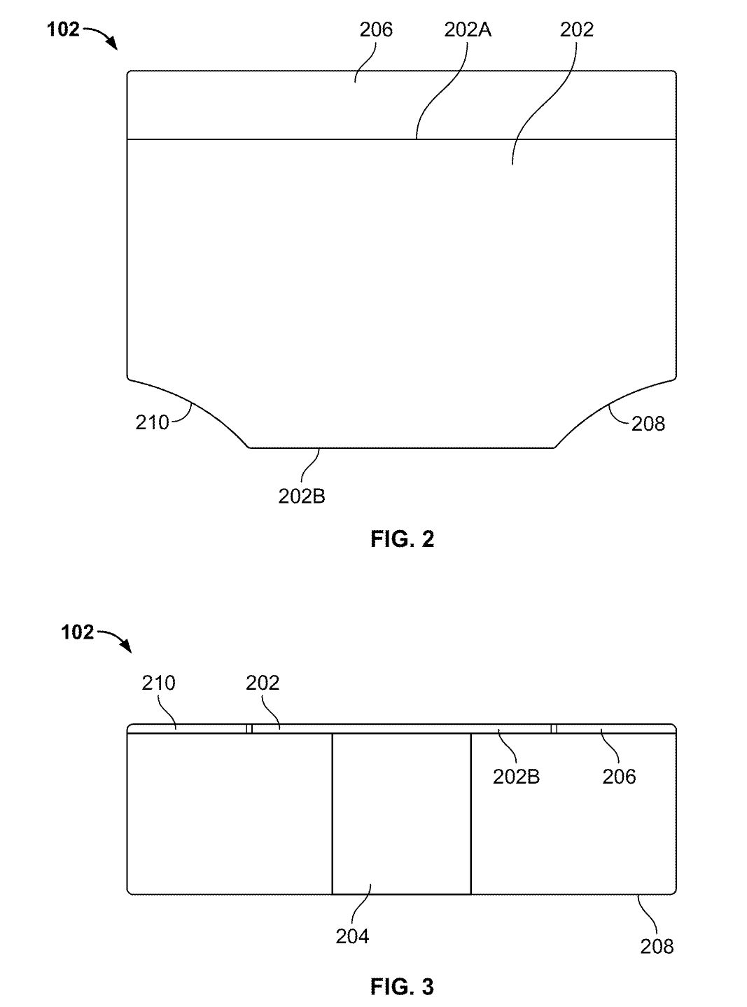

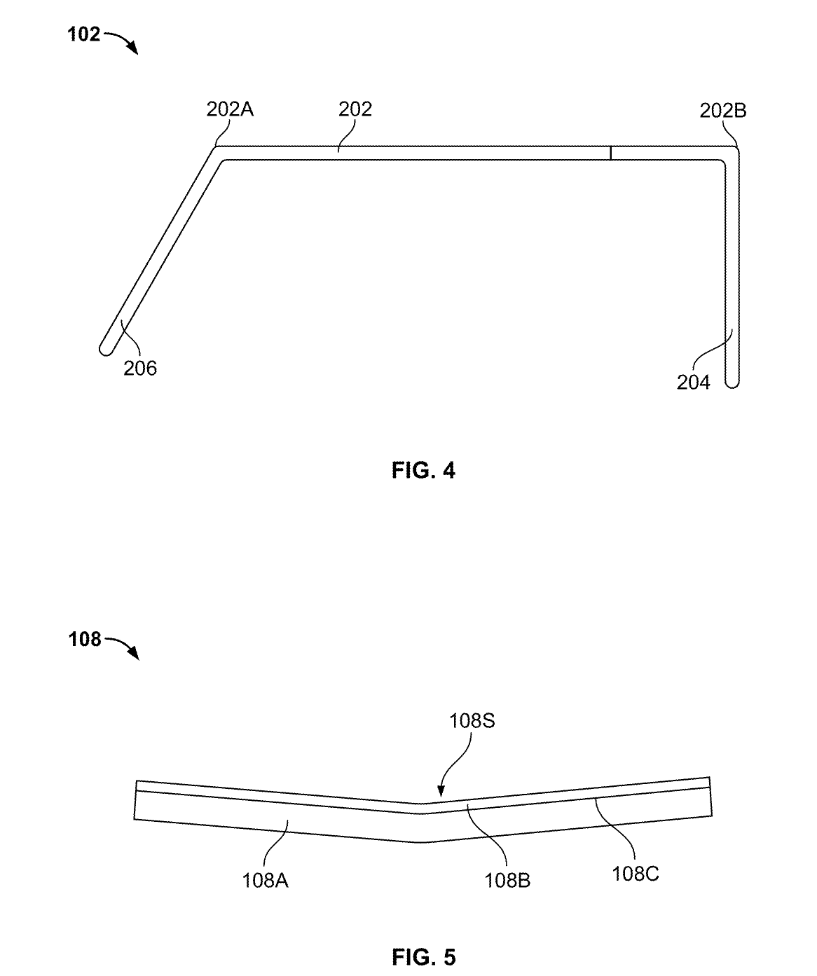

Referring to FIGS. 1-4, an example base 102 may include a main section 202, a tab 204, and/or an angled section 206. Tab 204 may extend generally perpendicularly downwardly from a rear edge 202B of main section 202. In some example embodiments, tab 204 may be narrower than base 102 and/or may extend from only a portion of rear edge 202B. Main section 202 may include one or more cut-outs 208, 210. In some example embodiments, cut-outs 208, 210 may be generally curved and may be located at the corners of the rear edge 202B. Angled section 206 may extend downwardly from a front edge 202A of main section 202, such as at about 30 degrees from vertical (e.g., about 120 degrees relative to main section 202). In some example embodiments, angled section 206 may extend across substantially the entire length of front edge 202A.

Referring to FIGS. 1 and 5, an example tank support 108 may be generally in the form of an elongated rectangle. In some example embodiments, tank support 108 may be shaped to engage a surface of a fuel tank, such as by including an at least partially concave upper surface 108S. For example, tank support 108 may have a generally V-shaped profile when viewed from the end such that the generally elongate rectangular tank support 108 forms a longitudinal trough. In some example embodiments, tank support 108 may include a plurality of layers, such as a structural layer 108A (e.g., metal, carbon fiber, plastic, etc.), a padding layer 108B (e.g., rubber), and/or an interface layer 108C (e.g., adhesive, double-sided tape, etc.), which may be configured to join padding layer 108B to structural layer 108A. Padding layer 108B may form at least part of concave surface 108S, which may reduce the likelihood of damage to an object supported by tank support 108.

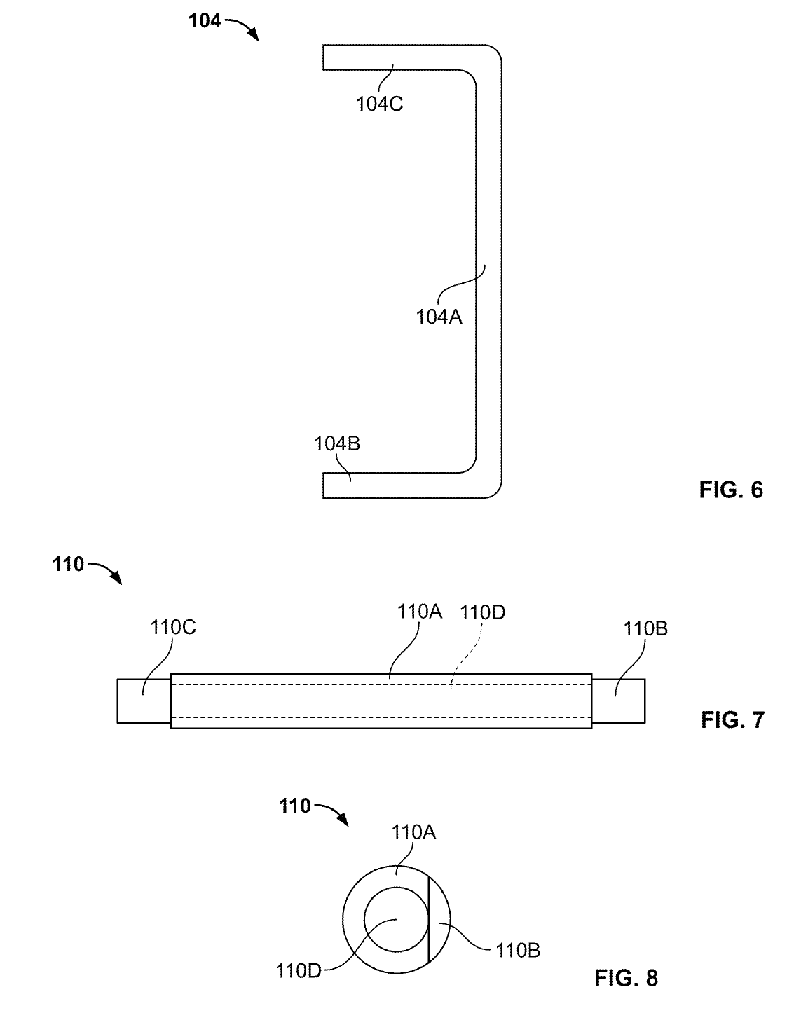

FIG. 6 illustrates an example arm 104, which may be substantially identical to arm 106. Arm 104 may include a substantially straight, generally vertical section 104A. A base horizontal section 104B may extend laterally from a lower end of vertical section 104A and/or may be configured to be received in hinge barrel 110. A tank support horizontal section 104C may extend laterally from an upper end of vertical section 104A and/or may be configured to be received in tank support beam 112. In some example embodiments, arm 104 may be formed generally in a C-shape with base horizontal section 104B and tank support horizontal section 104C extending from vertical section 104A in generally the same direction.

FIGS. 7 and 8 illustrate an example hinge barrel 110, which may be generally tubular and/or may include a longitudinal channel 110D. Channel 110D may receive base horizontal section 104B of arm 104 and/or a corresponding base horizontal section of arm 106. One or both ends of hinge barrel 110 may be cut away to provide tabs 110B, 110C. As shown in FIG. 9, hinge barrel 110 may be mounted to base 102 such that tabs 110B, 110C may obstruct rotation of arms 104, 106 about hinge barrel 110 at a predetermined degree of rotation. For example, hinge barrel 110 may be mounted to base 102 such that tabs 110B, 110C may obstruct rotation of arms 104, 106 when arms 104, 106 are about perpendicular relative to base 102. Thus, arms 104, 106 may rotate from about parallel with base 102 (e.g., FIG. 9) to about perpendicular to base 102 (e.g., FIG. 1). In some example embodiments, hinge barrel 110 may be mounted to base 102 to provide other ranges of rotation.

FIG. 9 illustrates fuel tank stand 100 in a collapsed configuration. FIG. 9 also illustrates tank support beam 112, which may receive tank support horizontal section 104C of arm 104 and/or a corresponding tank support horizontal section of arm 106.

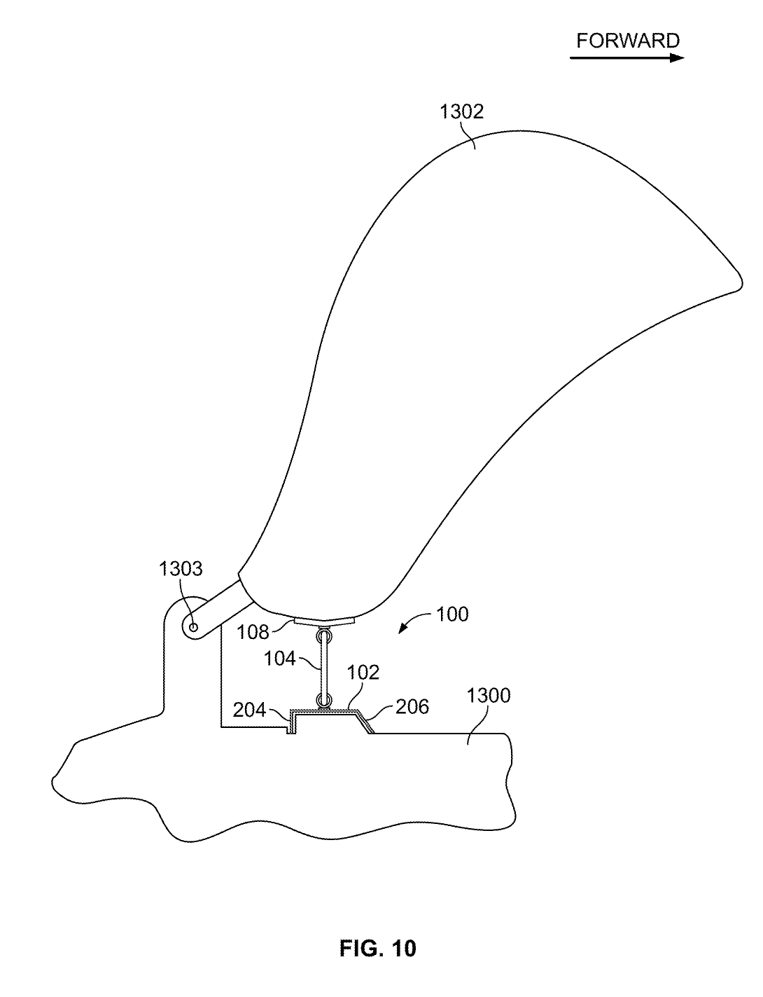

FIG. 10 illustrates fuel tank stand 100 installed on a motorcycle chassis 1300 generally beneath a fuel tank 1302 approximate a pivot point 1303 where the fuel tank 1302 is pivotally mounted to the motorcycle chassis. In some example embodiments, base 102 may be seated on the upper rear cross member of the main frame, tab 204 may be located between the shock mount ears or tabs, and/or angled section 206 may be seated on the forward face of the frame cross member. In the upright configuration, fuel tank stand 100 may at least partially support fuel tank 1302 in a lifted or open orientation. Thus, with fuel tank stand 100 in the upright configuration holding up the lifted or opened fuel tank 1302, components located generally beneath fuel tank 1302 may be accessible.

Some example embodiments may be installed by raising fuel tank 1302 by pivoting up the forward end of the tank about pivot point 1303, installing fuel tank stand 100 beneath fuel tank 1302, placing fuel tank stand 100 in the upright configuration, and/or lowering fuel tank 1302 onto fuel tank stand 100. Fuel tank 1302 may be restored to its normal, lowered or closed position by raising fuel tank 1302 of off fuel tank stand 100, placing fuel tank stand 100 into the collapsed configuration, and/or lowering fuel tank 1302. Some example embodiments may remain in place beneath fuel tank 1302 (e.g., in the collapsed configuration) during normal operation of the motorcycle. Thus, subsequent uses of tank stand 100 may include raising fuel tank 1302 by pivoting up the forward end of the tank about pivot point 1303, placing fuel tank stand 100 in the upright configuration, and/or lowering fuel tank 1302 onto fuel tank stand 100.

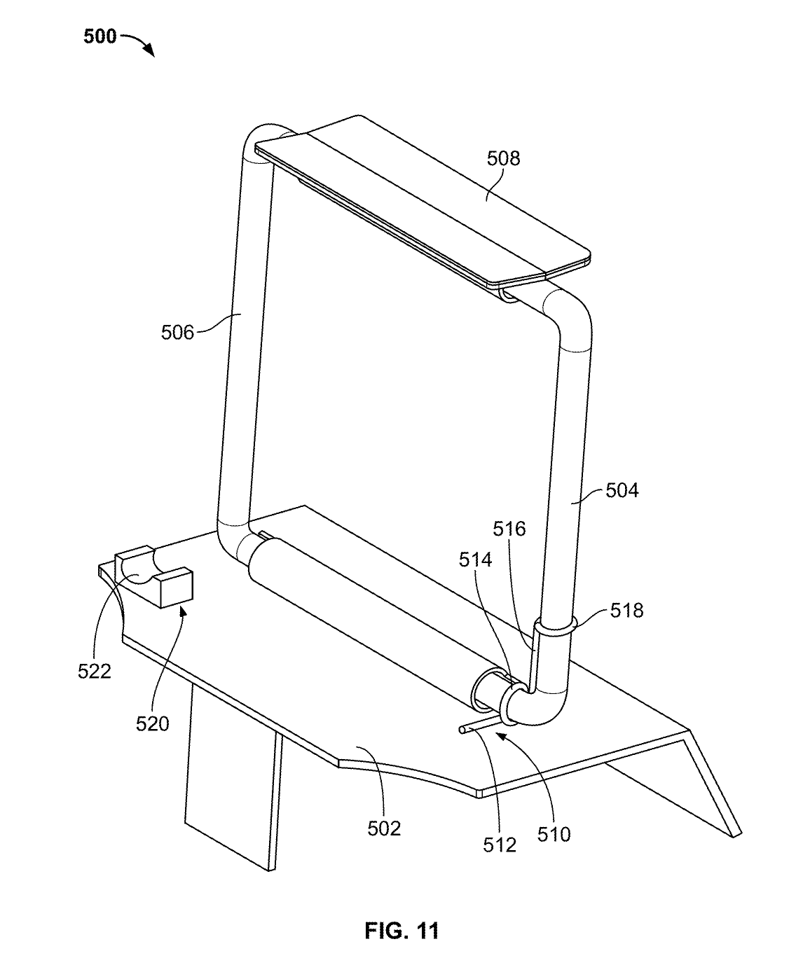

FIG. 11 illustrates an example tank stand 500, which may be generally similar to fuel tank stand 100 described above. Fuel tank stand 500 may include a base 502, one or more arms 504, 506, and/or a tank support 508. Fuel tank stand 500 may include one or more springs or other biases, such as torsion spring 510, which may be arranged to fuel tank stand 500 into its upright configuration. Torsion spring 510 may include a generally horizontally extending leg 512 (which may engage base 502), a coil portion 514 (which may receive a portion of leg 504), a generally vertically extending leg 516, and/or a hook 518 (which may engage leg 504). Torsion spring 510 may be configured such that moving fuel tank stand 500 from its upright configuration to its collapsed configuration elastically deforms torsion spring 510. Some example embodiments according to at least some aspects of the present disclosure may include one or more latches, such as latch 520, which may be configured to engage and retain arm 506 in the collapsed configuration (e.g., against the force of spring 510).

In some example embodiments, the force of spring 510 may be sufficient to rotate arms 504, 506 into the upright configuration substantially without operator assistance. Some example embodiments may be operated by raising fuel tank 1302, releasing latch 520, which may allow arms 504, 506 to rotate into the upright configuration, and then lowering fuel tank 1302 onto tank support 508. Similarly, fuel tank 1302 may be raised, arms 504, 506 may be rotated into the collapsed configuration, latch 520 may be engaged to hold arms 504, 506 in the collapsed configuration, and fuel tank 1302 may be lowered.

Some example embodiments may be constructed at least partially from one or more metals (e.g., steel, aluminum, etc.). In such example embodiments, various components may be joined by welding, for example. Some example embodiments may be constructed at least partially from composite materials, such as fiber-reinforced composite materials. For example, some example embodiments may be constructed at least partially from fiberglass and/or carbon fiber. Some example embodiments may be constructed at least partially of plastic.

Although example embodiments have been described herein with reference to a motorcycle chassis, it is within the scope of the disclosure to utilize example embodiments in connection with other vehicles, such as all-terrain vehicles, automobiles, trucks, vans, scooters, etc.

While example embodiments have been set forth above for the purpose of disclosure, modifications of the disclosed embodiments as well as other embodiments thereof may occur to those skilled in the art. Accordingly, it is to be understood that the disclosure is not limited to the above precise embodiments and that changes may be made without departing from the scope. Likewise, it is to be understood that it is not necessary to meet any or all of the stated advantages or objects disclosed herein to fall within the scope of the disclosure, since inherent and/or unforeseen advantages may exist even though they may not have been explicitly discussed herein.

What is claimed is:

1. A fuel tank stand for a vehicle, the vehicle including a chassis and a fuel tank pivotably mounted to the chassis, at a pivoting end of the fuel tank, so as to be pivoted up from a closed position to an open position in which an end of the fuel tank opposite the pivoting end is lifted to provide access beneath the fuel tank, the fuel tank stand comprising:
a base configured to be mounted to a chassis of the vehicle, beneath the fuel tank and approximate the pivoting end of the fuel tank;
at least one arm comprising a first end pivotably mount to the base, so as to be pivotable between a generally horizontal collapsed position to a generally vertical upright position; and
a tank support mounted to a second end of the at least one arm opposite the first end, the tank support being configured to selectively engage and at least partially support the fuel tank of the vehicle in its open position when the at least one arm is in the generally vertical upright position.

2. The fuel tank stand of claim 1, wherein the base comprises a substantially flat main section, a tab extending from a first edge of the main section, and an angled section extending from a second edge of the main section.

3. The fuel tank stand of claim 2, wherein the first edge and the second edge are generally opposed.

4. The fuel tank stand of claim 2, wherein the tab extends generally perpendicularly downwards from the main section.

5. The fuel tank stand of claim 2, wherein the angled section extends downwardly from the main section at about 30 degrees from vertical.

6. The fuel tank stand of claim 2, wherein the tab is substantially narrower than the main section.

7. The fuel tank stand of claim 2, wherein the angled section is substantially the same width as the main section.

8. The fuel tank stand of claim 1, wherein the tank support comprises an at least partially concave surface configured to contact the fuel tank.

9. The fuel tank stand of claim 1, wherein the tank support comprises a padding layer and a structural layer.

10. The fuel tank stand of claim 9, wherein the tank support comprises an interface layer interposing the padding layer and the structural layer.

11. The fuel tank stand of claim 1, wherein the at least one arm comprises a generally vertical section, a base horizontal section, and a tank support horizontal section.

12. The fuel tank stand of claim 11, further comprising a hinge barrel mounted to the base, the hinge barrel rotatably receiving at least a portion of the base horizontal section of the arm.

13. The fuel tank stand of claim 12, wherein the hinge barrel comprises a tab configured to limit rotation of the arm relative to the base.

14. The fuel tank stand of claim 13, wherein the tab is configured to limit rotation of the arm relative to the base to about 90 degrees.

15. The fuel tank stand of claim 11, further comprising a tank support beam mounted to the tank support, the tank support beam receiving at least a portion of the tank support horizontal section of the arm.

16. The fuel tank stand of claim 1, wherein the at least one arm comprises two arms.

17. The fuel tank stand of claim 1, further comprising a bias operatively coupled to the at least one arm and arranged to bias the at least one arm towards the generally vertical upright position.

18. The fuel tank stand of claim 17, further comprising a latch configured to retain the at least one arm in the generally horizontal collapsed configuration wherein the bias is elastically deformed.

19. The fuel tank stand of claim 18, further comprising a base configured to engage the chassis of a vehicle, the first end of the at least one arm being pivotally mounted to the base.

20. The fuel tank stand of claim 17, wherein the spring comprises a torsion spring.

21. A motorcycle comprising:
a chassis;
a fuel tank pivotably mounted to the chassis, at a pivoting end of the fuel tank, so as to be pivoted up from a closed position to an open position in which an end of the fuel tank opposite the pivoting end is lifted to provide access beneath the fuel tank; and
a fuel tank stand including
a base mounted to the chassis beneath the fuel tank and approximate the pivoting end of the fuel tank,
at least one arm comprising a first end pivotably mount to the base, so as to be pivotable between a generally horizontal collapsed position to a generally vertical upright position, and
a tank support mounted to a second end of the at least one arm opposite the first end, the tank support being configured to selectively engage and at least partially support the fuel tank of the vehicle in its open position when the at least one arm is in the generally vertical upright position.

22. The motorcycle of claim 21, wherein the pivoting end of the fuel tank is located generally rearward and the end of the fuel tank opposite the pivoting end is located generally forward.

23. A method for supporting a fuel tank of a vehicle in an open position using a fuel tank stand, the fuel tank being pivotably mounted to the chassis, at a pivoting end of the fuel tank, so as to be pivoted up from a closed position to the open position in which an end of the fuel tank opposite the pivoting end is lifted to provide access beneath the fuel tank, the method comprising:
pivoting the fuel tank from the closed position to approximate the open position;
placing a fuel tank stand into an upright configuration by pivoting at least one arm from a generally horizontal collapsed position to a generally vertical upright position, the arm comprising a first end pivotably mount to a base, the base being mounted to a chassis of the vehicle generally beneath the fuel tank and approximate the pivoting end of the fuel tank; and
lowering the fuel tank onto a tank support of the fuel tank stand, the tank support being mounted to a second end of the at least one arm opposite the first end and being configured to selectively engage and at least partially support the fuel tank in the open position when the at least one arm is in the generally vertical upright position.

24. The method of claim 23, further comprising
raising the fuel tank off of the tank support;
placing the fuel tank stand into the generally horizontal collapsed position by pivoting the at least one arm about the base; and
lowering the fuel tank into the closed position.

25. The method of claim 23, further comprising, prior to placing the fuel tank stand into the upright configuration, installing the fuel tank stand on the chassis of the vehicle generally beneath the fuel tank and approximate the pivoting end of the fuel tank.
